(19) United States
(12) Patent Application Publication
(10) Pub. No.: US 2010/0112375 A1
(43) Pub. Date: May 6, 2010

(54) LIGHTWEIGHT WEAR-RESISTANT WELD OVERLAY

(75) Inventor: Stefano CHIOVELLI, Edmonton (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(73) Assignees: CANADIAN OIL SANDS LIMITED PARTNERSHIP, Calgary (CA); CANADIAN OIL SANDS LIMITED, Calgary (CA); CONOCOPHILLIPS OILSANDS PARTNERSHIP II, Calgary (CA); IMPERIAL OIL RESOURCES, Calgary (CA); MOCAL ENERGY LIMITED, Tokyo (JP); NEXEN INC., Calgary (CA); MURPHY OIL COMPANY LTD., Calgary (CA); PETRO-CANADA OIL AND GAS, Calgary (CA)

(21) Appl. No.: 12/606,992

(22) Filed: Oct. 27, 2009

Related U.S. Application Data
(63) Continuation of application No. 10/906,486, filed on Feb. 22, 2005, now abandoned.

(51) Int. Cl. B32B 15/01; B32B 15/04; B23K 10/02

(52) U.S. Cl. 428/654; 428/615; 428/650; 428/684; 219/76.16

(57) ABSTRACT

A powder form of a hard phase component, selected from the group consisting of boron carbide, silicon carbide and a mixture of boron carbide and silicon carbide, is combined with an aluminum alloy matrix powder and applied to a metal substrate using plasma transferred arc (“PTA”) welding to produce a hardfaced structure having a wear-resisting carbide metal matrix composite overlay. The metal substrate can be any metal structure, such as an aluminum, aluminum alloy, steel or carbon steel structure, where wear resistance is desirable. Further, a process for hardfacing a metal substrate is disclosed comprising feeding a hard phase powder, selected from the group consisting of boron carbide, silicon carbide and a mixture of boron carbide and silicon carbide, and an aluminum alloy metal matrix powder to an operative PTA welding torch and welding to form a carbide metal matrix composite overlay fused to a metal substrate. The metal substrate produced by the hardfacing process herein exhibits increased wear resistance without a significant increase in the overall weight of the metal substrate.

### CROSS REFERENCE TO RELATED APPLICATIONS

This is a continuation application of U.S. application Ser. No. 10/906,486 filed Feb. 22, 2005 and presently pending.

The present invention relates generally to a wear-resistant weld overlay applied to a substrate and to a process for producing the resulting hardfaced structure. More specifically, the present invention relates to a carbide metal matrix composite weld overlay which offers high wear resistance with reduced weight.

### BACKGROUND OF THE INVENTION

The invention has been developed in connection with hardfacing of metal components used in mining and processing of oil sand and it will be described herein in connection with that environment. However, it is contemplated that the invention may find application in other fields of use as well.

Oil sand is mined, trucked, slurried, conveyed in a pipeline and processed, using various equipment and vessels, all with the objective of recovering contained bitumen (a form of heavy viscous oil). Both the dry, as-mined oil sand and the slurry obtained by mixing the oil sand with heated water are particularly abrasive and erosive.

The industry has, therefore, for many years, conducted research and introduced improvements with respect to hardfacing the steel and other metal components that come in contact with the oil sand and slurry, to enable them to better withstand the wear.

One example of the progress achieved in this regard has to do with screens used to remove oversize ore from the slurry. Initially these screens were formed of carbon steel with no overlay. Thus, the life of such a screen was relatively short, in the order of 500,000 tons of slurry treated. To improve their life, the screens were then hardfaced with a chrome carbide weld overlay. The life of the screens were thereby extended to about 5,000,000 tons of slurry treated. Following this, tungsten carbide (WC) powder, the hard phase, was applied together with a powder matrix of Ni—Cr—B—Si, and the screens were hardfaced using an oxy-acetylene torch. The life of the screens were thereby extended to about 20,000,000 tons of slurry treated.

These achievements were hard won through years of experimentation. They involved successfully marrying selected overlay materials with selected welding techniques.

The current hardfacing system, involving WC, has problems associated with it. The WC has a relatively high density, in the order of 15.8-17.2 g/cm³, depending on the type of tungsten carbide used. The matrix (Ni—Cr—B—Si) has a density of about 8.9 g/cm³. As a result of the high densities and the difference in densities between the WC and Ni—Cr—B—Si matrix, the WC particles tended to sink in the weld pool and segregate. This is undesirable as one wants to maintain as even a distribution of the hard phase in the overlay as one can manage, to ensure uniform wear performance.

In addition, WC is relatively expensive. Further, the WC overlay is relatively heavy. If, for example a truck box is lined with the WC overlay, the load capacity of the truck is significantly diminished due to the added weight of the overlay. Finally, there is a narrow window of welding parameters that can be used to overlay with such a matrix.

It will therefore be appreciated that there has long existed a need for an overlay system that is relatively less expensive, relatively less likely to be characterized by hard phase segregation, easy to weld and amenable for preferred use with a lightweight metal substrate to produce a lightweight structure.

### SUMMARY OF THE INVENTION

In accordance with the invention, a powder form of a hard phase component, selected from the group consisting of boron carbide, silicon carbide and a mixture of boron carbide and silicon carbide, is combined with an aluminum alloy matrix powder and applied to a metal substrate using plasma transferred arc (“PTA”) welding to produce a hardfaced structure having a wear-resisting carbide metal matrix composite overlay.

The metal substrate can be any metal structure where wear resistance is desirable. The metal substrate can be comprised of any metal or combination of metals, for example, aluminum, aluminum alloy, steel, carbon steel and the like.

There are many commercial aluminum alloy matrix powders available, having alloying constituents such as zinc, magnesium, silicon, zirconium, titanium and the like, which can be used in accordance with the present invention.

In one embodiment the invention is directed to a hardfaced structure comprising: a metal substrate; and a weld overlay fused to the substrate, the overlay comprising an aluminum-containing metal matrix composite securing hard phase particles, selected from the group consisting of boron carbide, silicon carbide and a mixture of boron carbide and silicon carbide, distributed therein.

In a preferred embodiment, boron carbide powder is combined with an aluminum-silicon alloy matrix powder and applied by PTA welding to an aluminum or aluminum alloy substrate to produce a lightweight hardfaced structure. Alternatively the powders can be applied by PTA welding to a steel substrate, such as a slurry screen, to hardface the steel substrate. In a further preferred embodiment, the aluminum-silicon alloy matrix powder comprises aluminum and 12% by weight silicon, which is a eutectic mixture.

It is understood by those skilled in the art that the upper particle size limit of the hard phase particles is determined by the plasma torch design for the powder feed of the PTA welding equipment. It is further understood that the lower size limit is determined based on the survivability (decomposition) of the smaller hard particles as the particles are transferred through the welding arc.

Thus, in a preferred embodiment, the hard phase particles have a mean particulate size greater than about 20 microns to about 1000 microns. In a further preferred embodiment, the hard phase particles have a particulate size ranging between about 53 microns and about 210 microns, with a mean or average size of approximately 100 microns.

In another embodiment, the invention is directed to a process for hardfacing a metal substrate comprising: feeding a hard phase powder, selected from the group consisting of boron carbide, silicon carbide and a mixture of boron carbide and silicon carbide, and an aluminum alloy metal matrix powder to an operative plasma transferred arc welding torch; and welding to form a carbide metal matrix composite overlay fused to a metal substrate.

The metal substrate produced by the hardfacing process herein exhibits increased wear resistance without a significant increase in the overall weight of the metal substrate.

### BRIEF DESCRIPTION OF THE DRAWINGS

FIG. 1 is a schematic representation of the process for hardfacing a metal substrate according to an embodiment of the invention.

FIGS. 2a, 2b, 2c and 2d are photomicrographs of two of the Al—Si—B₄C weld overlays of the invention.

FIG. 3 is a photomicrograph of a 70 wt. % B₄C in 30 wt. % Al—Si weld overlay of the invention.

FIG. 4 is a schematic of the slurry jet erosion test rig used to measure wear resistance.

FIG. 5 illustrates a volume loss (mm³) versus impingement angle (degree) graph for welded structures of the invention having been hardfaced with various Al—Si—B₄C overlays.

FIGS. 6(a), 6(b) and 6(c) are scanning electron micrographs showing the erosion/wear of a 30% Al—Si-70% B₄C overlay at 20°, 45° and 90° impingement angles, respectively

FIGS. 7(a), 7(b) and 7(c) are scanning electron micrographs showing the erosion/wear of a 35% Ni—Cr—B-65% WC overlay at 20°, 45° and 90° impingement angles, respectively.

FIG. 8 is a bar graph showing the volume loss (mm³) using ASTM G 65 testing procedure for welded structures of the invention having been hardfaced with various Al—Si—B₄C/SiC overlays.

FIGS. 9(a) and 9(b) are scanning electron micrographs at 35 times and 150 times magnification, respectively, of a ASTM G 65 wear scar for a 30% Al—Si-70% B₄C overlay.

FIG. 10 illustrates a volume loss (mm³) versus impingement angle (degree) graph for welded structures of the invention having been hardfaced with a weld overlay comprising 40 wt. % Al-12 wt. % Si+30 wt. % B₄C+30 wt. % SiC.

FIG. 11 is a photomicrograph of a weld overlay comprising 40 wt. % Al-12 wt. % Si+30 wt. % B₄C+30 wt. % SiC.

### DESCRIPTION OF THE PREFERRED EMBODIMENT

The invention is exemplified by the following description and examples.

### Example I

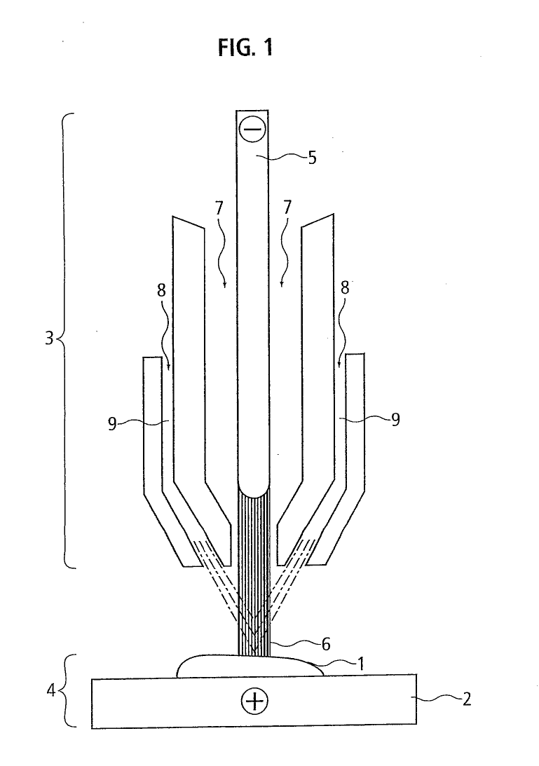

With reference to FIG. 1, a plasma transferred arc (“PTA”) welding machine 3 comprising electrode 5 connected to the negative terminal of a power supply (not shown) is provided. The hardfacing substrate, aluminum substrate 2, is connected to the positive terminal of the power supply. A primary arc of inert gas 7 is established between electrode 5 and aluminum substrate 2 to create a plasma column 6.

A powder of hardfacing material 8, comprising a mixture of boron carbide powder (hard phase particle) and aluminum-silicon alloy powder (metal matrix), is introduced into passage 9, typically by use of an inert gas as a carrier. While in the plasma column 6, at least one component of the hardfacing material 8 is melted by the plasma column 6 and a weld 1 of hardfacing material is applied to aluminum substrate 2 to form welded structure 4. This process was repeated with a number of samples to yield welded structures for examination.

More particularly, the process was carried out as follows:
boron carbide (B₄C) powder (−70/+270 mesh size) was obtained from ElectroAbrasive, Inc.; the powder had a density of 2.54 g/cm³;
aluminum—12 wt. % silicon (Al—Si) alloy powder (−140/+325 mesh size) was obtained from Eutectic Canada Inc.; the powder had a density of 3.21 g/cm³;
the B₄C and Al—Si powders were blended in the following range of proportions: 0% by wt. B₄C and 100% by wt. Al—Si to 70% by wt. B₄C and 30% by wt. Al—Si;
the 12″ long×3″ wide×1″ thick 6061 T6 aluminum substrate 2 was pre-heated to 100° C. in an oven prior to welding to assist in subsequent fusion;
the mixture of powders was fed in argon carrier gas at a rate of 6 Λ/min through the feed port of a Eutectic Gap 375 PTA welding machine 3 and torch;
samples were prepared in the following welding parameter ranges: current: 100-120 Amps; voltage: 27-30 V; travel speed 3.875-4.625 inches per minute, 1 inch weave size; powder feed rate: 11.5 g/min; plasma gas: 6 Λ/min; shielding gas: 25 Λ/min; and
the powder feed was deposited on top of the aluminum substrate 2 creating a weld overlay several mm thick.

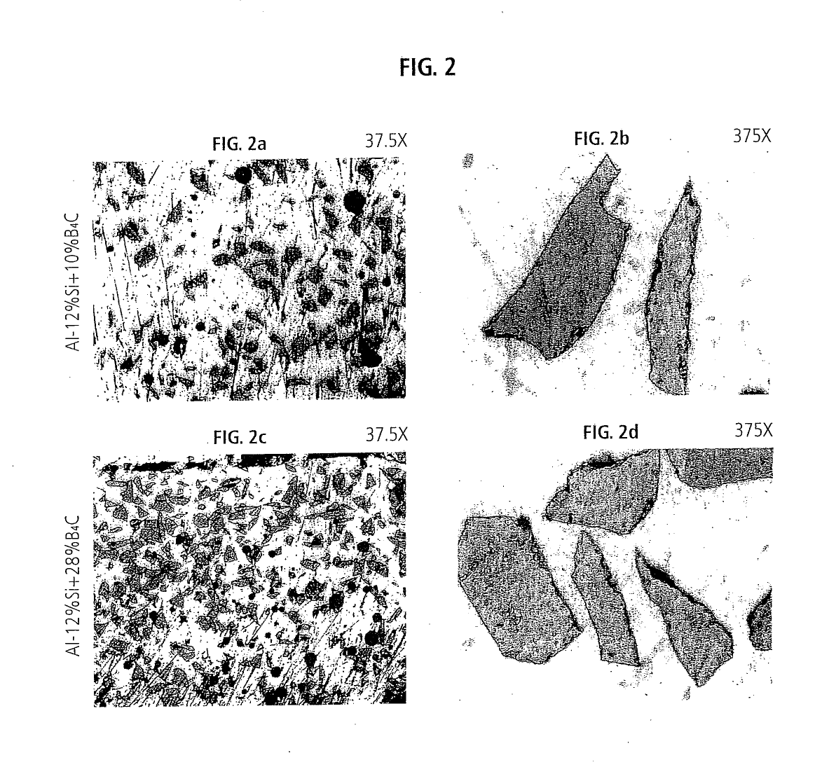

FIGS. 2a and 2c, and FIGS. 2b and 2d are photomicrographs at 37.5 times magnification and 375 times magnification, respectively, of two of the Al—Si—B₄C overlays so produced. The overlay shown in FIGS. 2a and 2b was produced from a powder mixture consisting of 10 wt. % B₄C in Al—Si. The overlay shown in FIGS. 2c and 2d was produced from a powder mixture consisting of 20 wt. % B₄C in Al—Si.

FIGS. 2a and 2c demonstrate that the boron carbide particles are relatively uniformly dispersed throughout the aluminum-silicon metal matrix in each overlay. Further, it can be seen in FIGS. 2b and 2d that the boron carbide particles are highly angular, indicating minimal decomposition of these particles during the PTA welding process, under the welding parameters that were used.

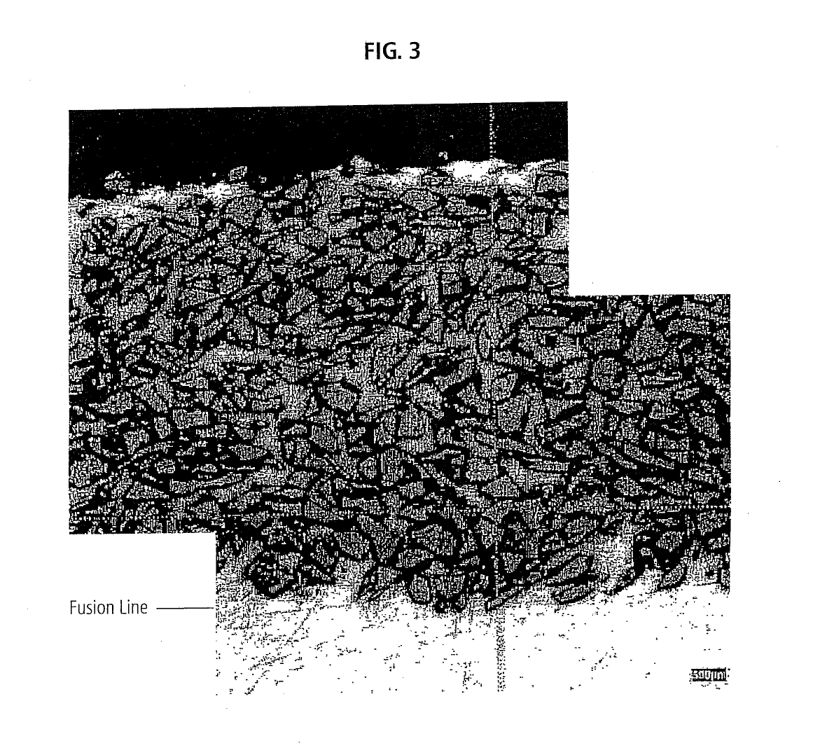

FIG. 3 is a photomicrograph showing an acceptable distribution of carbide particles when the PTA welding parameters described above were used to produce a welded sample having good wear resistance. The powder mixture used was 70 wt. % B₄C in 30 wt. % Al—Si. It can be seen in FIG. 3 that the boron carbide particles are uniformly dispersed and closely packed together, thus providing close to maximum wear resistance. Again, high angularity of the particles indicates minimal decomposition.

Welded structures 4 of Example I were subjected to sectioning, mounting and polishing for metallographic inspection and surface ground for dry sand rubber wheel wear resistance testing in accordance with the ASTM G 65 procedure. Slurry erosion tests were also performed on these samples at the National Research Council-Innovation Centre in Vancouver, Canada.

The ASTM G 65 Test Method for Measuring Abrasion Using the Dry Sand/Rubber Wheel Apparatus Low Stress is well known in the art and is described more fully in the standard. However, a modified Procedure A test was performed to more accurately rank the metal matrix composite materials of the invention. The modified test involved performing two Procedure A tests in the same wear scar. This was done because the first G 65 test essentially removes the matrix material resulting in an initially high wear rate. Once the matrix is removed, however, the hard carbides provide the wear resistance. Thus, the second G 65 test in the same wear scar more accurately represents the actual wear resistance of the metal matrix composite overlay.

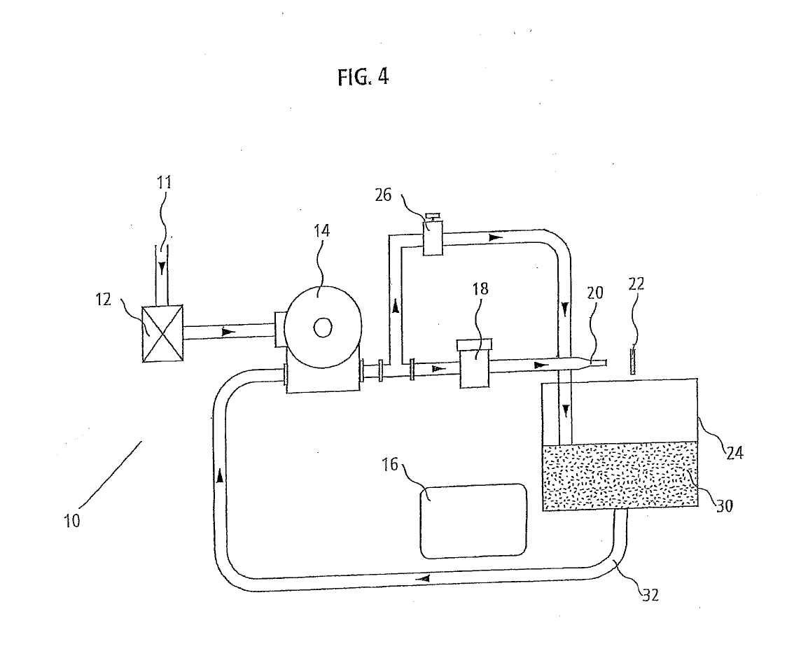

The slurry erosion test was performed to corroborate the results obtained with the G 65 test. The slurry erosion test can be best described with reference to slurry jet erosion test rig 10 shown in FIG. 4. The eroding material used in the slurry test is an 8% by weight AFS 50-70 Ottawa silica sand in a water slurry. Air 11 is supplied via electronic valve 12 to slurry pump 14. Computer 16 controls air pressure.

Silica sand slurry 30 is housed in slurry tank 24 and fed to slurry pump 14 via slurry line 32. Flow meter 18 measures the rate in which the silica sand slurry is feed through nozzle 20, said nozzle 20 having a nozzle orifice diameter of 5 mm. Nozzle 20 is directed at hardfaced sample structure 22, which preferably is located approximately 120 mm away from it.

The impingement angle of the slurry jet onto sample structure 22 can be adjusted as required. As a standard, testing is performed at 20°, 45° and 90° impingement angles. Spent silica sand slurry 30 is collected in slurry tank 24 and recycled through slurry pump 14 for repeated use. Slurry by-pass valve 26 allows silica sand slurry 30 to by-pass nozzle 20.

Each hardfaced sample structure 22 is then measured for volume loss (mm³). Volume loss is directly measured by laser profilometry.

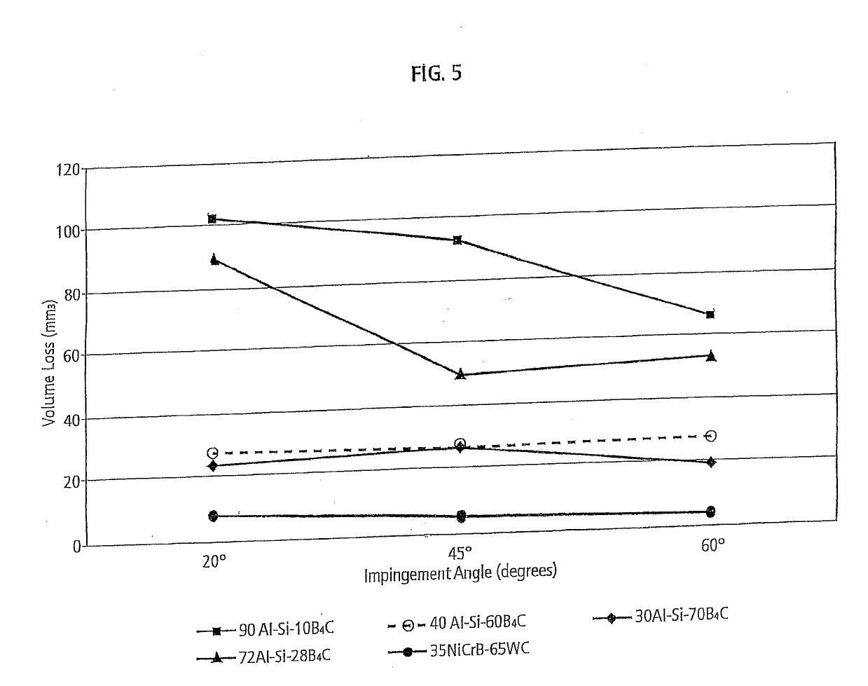

FIG. 5 shows the slurry erosion test results for four sample structures having been hardfaced with four different overlays comprising 90% Al—Si—10% B₄C, 72% Al—Si-28% B₄C, 40% Al—Si-60% B₄C and 30% Al—Si-70% B₄C. The volume loss of each sample structure was measured and compared to a sample structure having been hardfaced with a 35% Ni—Cr—B-65% WC overlay. The results in FIG. 5 demonstrate that erosion or wear resistance (as demonstrated by a decrease in volume loss (mm³) of the sample structures) increases significantly with the increase in carbide particles added to the Al—Si metal matrix. The sample structure comprising the 30% Al—Si-70% B₄C overlay was shown to have the closest wear resistance to 35% Ni—Cr—B-65% WC.

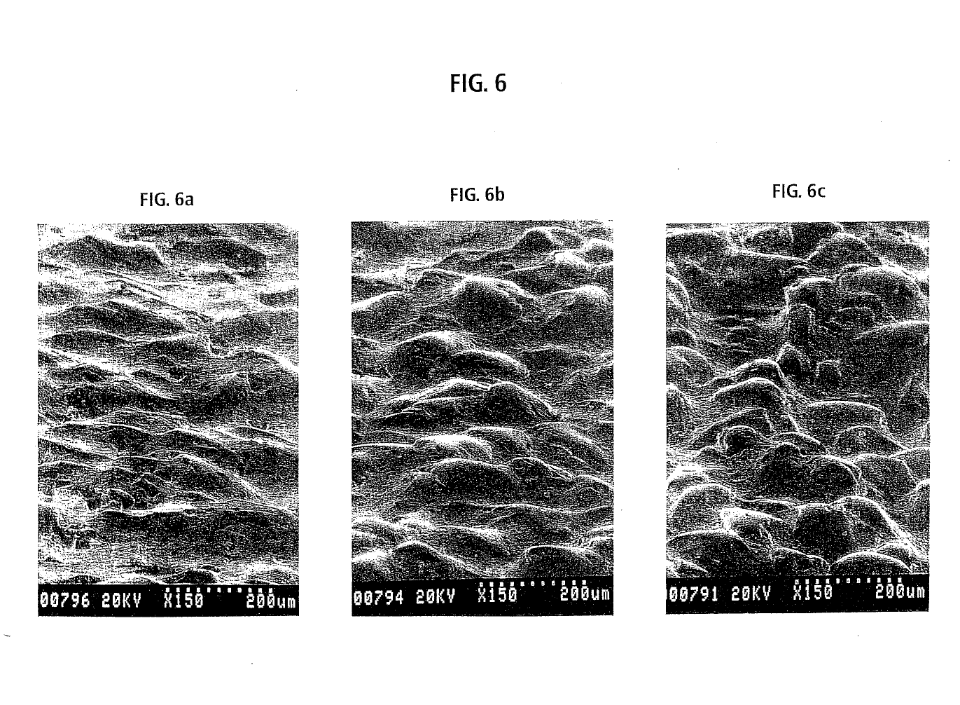

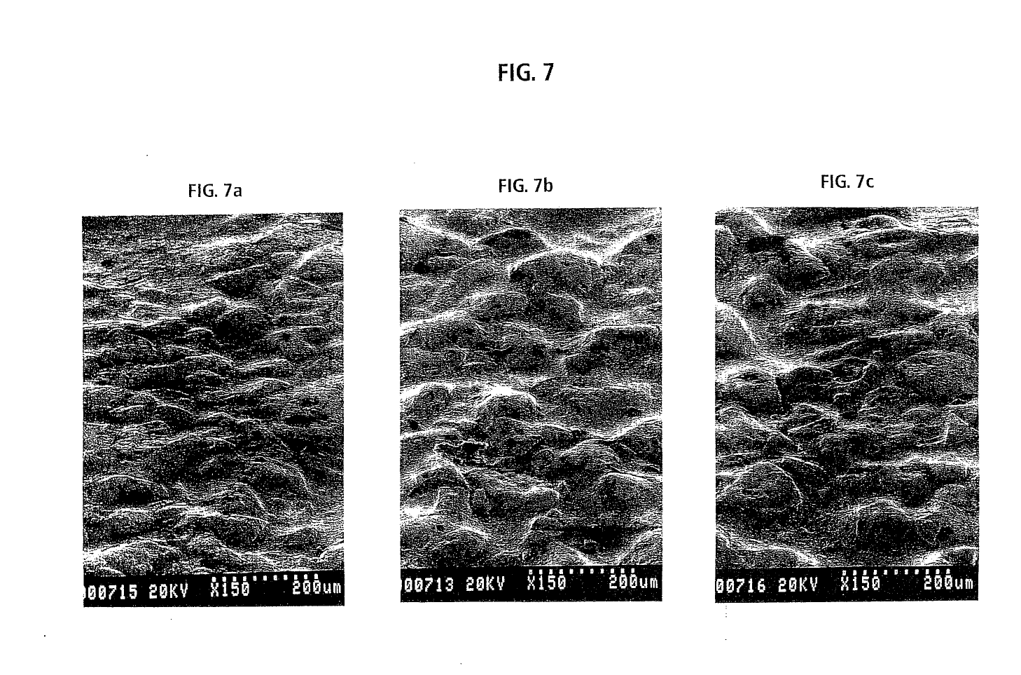

FIGS. 6(a), 6(b) and 6(c) are scanning electron micrographs showing the erosion/wear of the 30% Al—Si-70% B₄C overlay at 20°, 45° and 90° impingement angles, respectively. For comparison, FIGS. 7(a), 7(b) and 7(c) are scanning electron micrographs showing the erosion/wear of the 35% Ni—Cr—B-65% WC overlay at 20°, 45° and 90° impingement angles, respectively. It can be seen that the erosion/wear scars look similar in appearance for both the 30% Al—Si-70% B₄C overlay and the 35% Ni—Cr—B-65% WC overlay. The boron carbide samples look slightly more polished but there was no significant evidence of particle fracture in the locations that were observed.

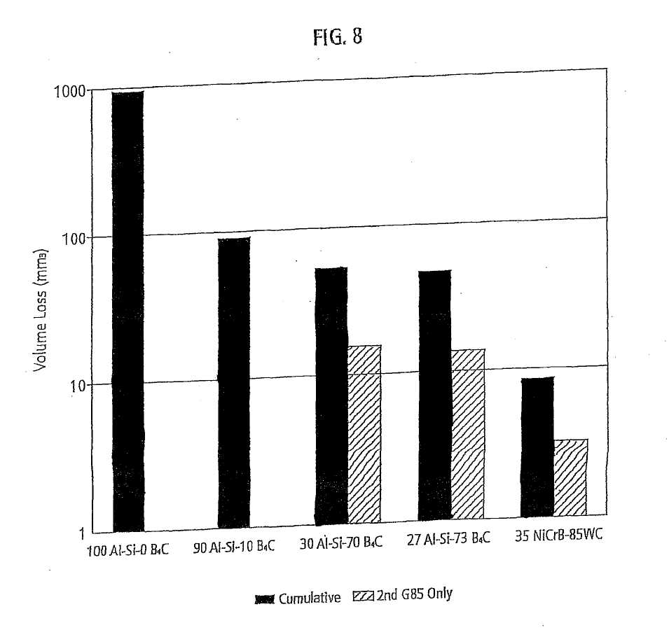

FIG. 8 is a bar graph showing the ASTM G 65 results for sample structures comprising various Al—Si—B₄C weld overlays of the invention. The results in FIG. 8 also demonstrated that that erosion or wear resistance (as demonstrated by a decrease in volume loss (mm³) of the sample structures) increased significantly with the increase in carbide particles added to the Al—Si metal matrix. The sample structure comprising the 27% Al—Si-73% B₄C weld overlay was shown to have the closest wear resistance to 35% Ni—Cr—B-65% WC.

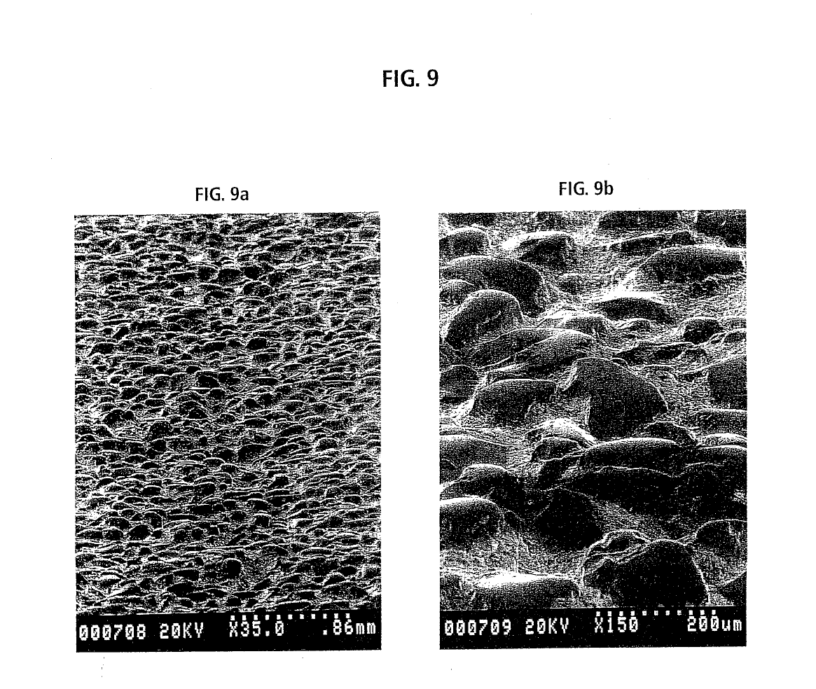

FIGS. 9(a) and 9(b) are scanning electron micrographs at 35 times and 150 times magnification, respectively, of a ASTM G 65 wear scar for a 30% Al—Si-70% B₄C overlay. The wear scar was similar to that of 35% Ni—Cr—B-65% WC (not shown).

### Discussion Relative to Example I

A reasonably wide range of welding parameters produced results similar to the foregoing. This is in contrast to the very tight controls on welding parameters one requires when PTA welding WC—Ni—Cr—B—Si overlays to produce acceptable carbide distribution throughout the weld. The welding parameters are controlled by WC decomposition and poor distribution (due to slower cooling rates) at higher welding heat inputs and lack of fusion at low heat inputs.

The poor distribution of WC in Ni—Cr—B—Si metal matrix material is partially due to the significantly different densities of WC and WC/W₂C (15.8-17.2 g/cm³) compared to approximately 8.9 g/cm³ for nickel alloys. In contrast, B₄C or SiC with densities of 2.52 and 3.21 g/cm³, respectively, are much more compatible with aluminum which has a density of 2.7 g/cm³. Practically, this means that a much larger welding parameter window is possible with the present system, which allows the welder more flexibility in how welding is performed.

The matrix powder used in the experimental runs was Al-12 wt. % Si alloy, which is a eutectic composition. This material yields a low melting point (approx. 575° C.) when compared to Al-6061, which melts in the range of 582-652° C. While Al-6061 does produce acceptable uniform distribution of the carbide particles, the use of the eutectic Al-12 wt. % Si alloy ensures that the Al-12 wt. % Si alloy welds cool very rapidly, essentially going directly from a liquid to a solid. This allows for optimal uniform distribution of the carbide particles.

The low density of the combined PTA Al-12 wt. % Si—B₄C weld overlay yields a low weight, wear-resistant material that could be used in applications where weight restrictions are of concern. As an example, power shovels and other excavating equipment used in mining applications can have literally tons of wear protection to ensure reasonable equipment life. This directly reduces the payload carrying capacity of these units. Using lightweight wear protection could not only provide an adequate level of wear protection but also increase the productivity of the equipment by potentially increasing the payload capacity of the unit.

### Example II

This Example demonstrates that SiC can be substituted for some or all of the B₄C.

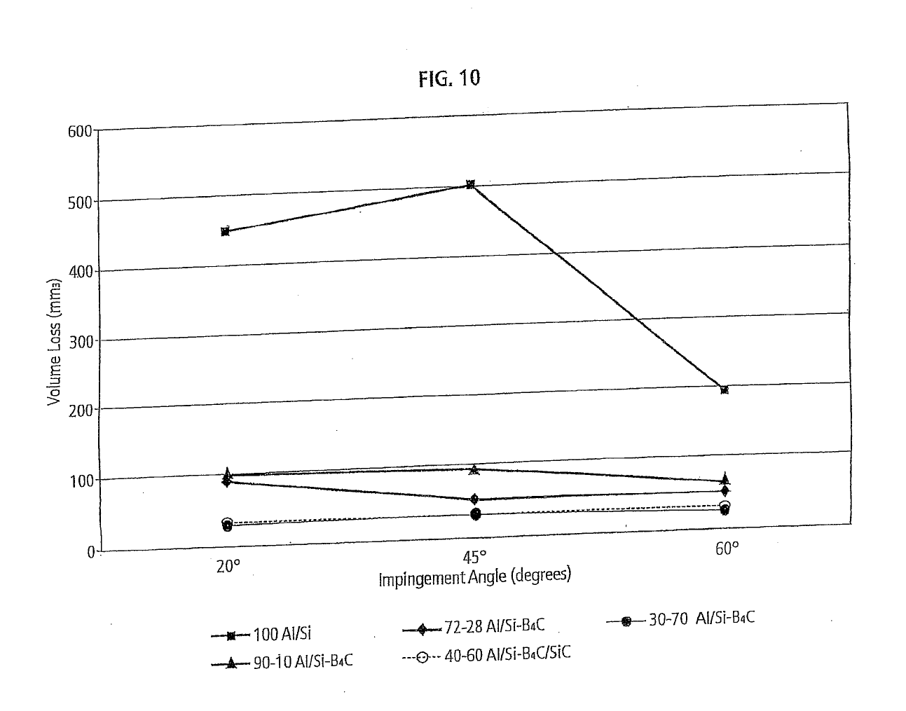

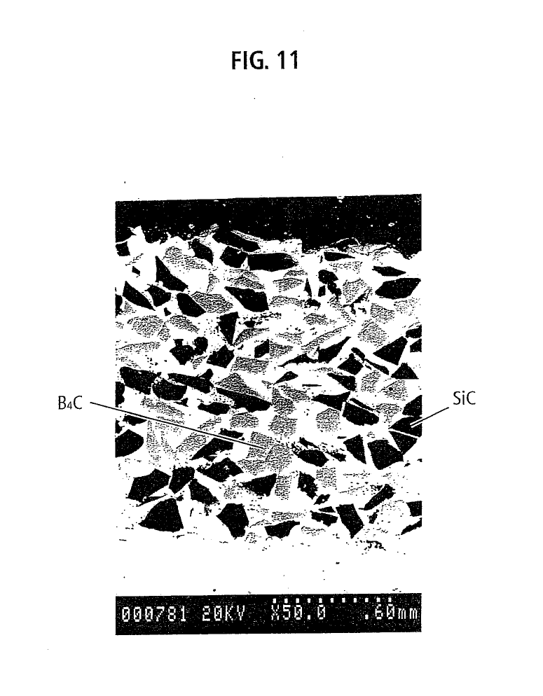

The same welding parameters, equipment and procedures were used to produce weld overlays using a 40 wt. % Al-12 wt. % Si+30 wt. % B₄C+30 wt. % SiC feed mixture as in Example I. FIG. 10 shows that this combination gave essentially the same erosion testing results as the 30 wt. % Al-12 wt. % Si+70 wt. % B₄C combination. Additionally, the photomicrograph in FIG. 11 shows that the dark phase (SiC) and the light phase (B₄C) carbides are very angular indicating little decomposition of the carbides during processing.

This substitution would be done in consideration of the properties required for the final weld overlay. It appears from FIG. 10 that erosion performance is acceptable for both the B₄C and B₄C/SiC mixture tested. However, the high silicon content of the aluminum alloy also inhibits the degradation of SiC, which begins decomposing at 1700° C. B₄C does not decompose but sublimes at 2400° C. It should be noted that these temperatures could be reached during processing as the powder is passed through the welding torch onto the substrate. The welding arc itself can reach temperatures of over 30000° K.

### Example III

The aluminum-carbide metal matrix composite overlays of the invention can be joined to most other metals either directly (as shown in Examples I and II) or indirectly by precoating the other metals or using a bi-metallic transition piece. For example, to hardface a carbon steel substrate, the overlay is deposited onto an intermediate alloy, which is placed onto the carbon steel substrate by a number of methods known to a person skilled in the art. This is often referred to in the art as “buttering” the steel with a “butter layer” such as a nickel or copper alloy.

Methods for buttering steel can be found in American Welding Society Welding Handbook, Materials and Applications-Part 1, “Aluminum and Aluminum Alloys, Joining to Other Metals”, (American Welding Society 1996), p. 97, and include the following:
1. brazing a nickel or copper based alloy onto the carbon steel surface;
2. roll bonding, cladding or explosion bonding a nickel or copper based alloy of at least ⅛″ in thickness onto the base carbon steel; and
3. Arc welding of suitable nickel or copper based metallurgy on top of a carbon steel substrate.

1. A hardfaced structure comprising:
a metal substrate; and
a weld overlay fused to the substrate, the overlay comprising an aluminum-12 wt. % silicon alloy metal matrix composite securing hard phase particles, said hard phase particles selected from the- group consisting of boron carbide, silicon carbide and a mixture of boron carbide and silicon carbide, distributed therein;
whereby when the overlay is fused to the metal substrate there is a substantial increase in the abrasion wear resistance of the hardfaced structure.

2. The hardfaced structure as set forth in claim 1 wherein the hard phase particles have a mean particulate size greater than about 20 microns.

3. The hardfaced structure as set forth in claim 1 wherein the hard phase particles have a mean particulate size greater than about 100 microns.

4. The hardfaced structure as set forth in claim 1 wherein the hard phase particles have a particulate size ranging between about 53 microns and about 210 microns.

5. The hardfaced structure as set forth in claim 1 wherein the metal substrate is selected from the group consisting of aluminum, aluminum alloys and steel.

6. A process for hardfacing a metal substrate comprising:
feeding a hard phase powder, selected from the group consisting of boron carbide and silicon carbide, and an aluminum-alloy metal matrix powder to an operative plasma transferred arc welding torch; and
welding to form a carbide metal matrix composite overlay fused to a metal substrate.

7. The process as set forth in claim 6 wherein the hard phase powder is boron carbide.

8. The process as set forth in claim 6 wherein the metal matrix powder comprises an aluminum-silicon alloy.

9. The process as set forth in claim 6 wherein the metal matrix composite comprises aluminum-12 wt % silicon alloy.

10. The process as set forth in claim 6 wherein the hard phase particles have an average particulate size greater than 20 microns.

11. The process as set forth in claim 6 wherein the substrate is formed of material selected from the group consisting of aluminum, aluminum alloy and steel.

12. The hardfaced structure as claimed in claim 1 wherein the overlay comprises between about 27 wt. % to about 90 wt. % aluminum-12 wt. % silicon alloy and between about 73 wt. % to about 10 wt. % hard phase particles, respectively.

13. The hardfaced structure as claimed in claim 1 wherein the overlay comprises about 40 wt. % aluminum-12 wt. % silicon alloy and about 60 wt. % hard phase particles.

14. The hardfaced structure as claimed in claim 1 wherein the overlay comprises about 30 wt. % aluminum-12 wt. % silicon and about 70 wt. % boron carbide.

15. The hardfaced structure as claimed in claim 1 wherein the overlay comprises about 40 wt. % aluminum-12 wt % silicon, about 30 wt. % boron carbide and about 30 wt. % silicon carbide.

16. A hardfaced structure comprising:
a metal substrate; and
a weld overlay fused to the substrate, the overlay comprising a eutectic aluminum-silicon alloy metal matrix composite securing hard phase particles, said hard phase particles selected from the group consisting of boron carbide, silicon carbide and a mixture of boron carbide and silicon carbide, distributed therein;
whereby when the overlay is fused to the metal substrate there is a substantial increase in the abrasion wear resistance of the hardfaced structure.

17. The hardfaced structure as claimed in claim 16 wherein the overlay comprises about 30 wt. % eutectic aluminum-silicon alloy and about 70 wt. % boron carbide.

18. The hardfaced structure as claimed in claim 16 wherein the overlay comprises about 40 wt. % eutectic aluminum-silicon alloy, about 30 wt. % boron carbide and about 30 wt. % silicon carbide.

19. A hardfaced structure comprising:
a metal substrate; and
a weld overlay fused to the substrate, the overlay comprising an aluminum-12 wt. % silicon alloy metal matrix composite securing hard phase particles, said hard phase particles consisting of boron carbide or a mixture of boron carbide and silicon carbide, distributed therein;
whereby when the overlay is fused to the metal substrate there is a substantial increase in the abrasion wear resistance of the hardfaced structure.
